(19) United States
(12) Patent Application Publication
(10) Pub. No.: US 2025/0215721 A1
(43) Pub. Date: Jul. 3, 2025

(54) BALLISTIC SHELTER AND METHOD FOR FABRICATING A BALLISTIC SHELTER

(71) Applicant: KENNO TECH OY, Riihimäki (FI)

(72) Inventors: Harri PEKKANEN, Katinala (FI); Timo PELTTARI, Riihimäki (FI); Rami VANNINEN, Rauma (FI)

(73) Assignee: KENNO TECH OY, Riihimäki (FI)

(21) Appl. No.: 18/875,304

(22) PCT Filed: Jun. 7, 2023
(86) PCT No.: PCT/FI2023/050330

§ 371 Date: Dec. 16, 2024

(30) Foreign Application Priority Data
Jun. 16, 2022 (FI) 20225537

(51) Int. Cl. E04H 9/04; E04C 3/28

(52) U.S. Cl. CPC E04H 9/04; E04C 3/28

(57) ABSTRACT

A ballistic includes a wall structure, a roof structure and triangular gable ends providing ballistic protection, whereby the aforementioned wall structure and roof structure has honeycomb board elements, whereby the ballistic shelter is self-supporting and has roof modules with at least two honeycomb board elements, a bottom chord and a center support, wall modules with at least a honeycomb board element and vertical support elements on the honeycomb board element of the side walls of the ballistic shelter as well as horizontal support elements at the corners of the ballistic shelter, and triangular gable end modules. The disclosure also includes a method for fabricating a ballistic shelter.

The object of the invention is a ballistic shelter and a method for fabricating a ballistic shelter according to the independent claims. The ballistic shelter according to the invention is assembled from honeycomb-structured modules without frame structures, in which case the ballistic shelter is self-supporting.

Various ballistic shelters are needed in conflict areas to safeguard personnel and equipment from injury and damage. Solutions according to prior art have focused on the development of ballistic shelters for personnel. These types of shelters are transported in vehicles along with troops, the vehicles also carrying other heavier equipment and supplies.

Such ballistic shelters are known from, inter alia, specification U.S. Pat. No. 20,211,02398 A1. This specification presents various erectable solutions for ballistic shelters for personnel. The solutions are shelters erectable by one or more persons together, which shelters are typically for one or a few persons and are A-shaped or have flat roofs. A-shaped ballistic shelters are erected by raising the hinge point at the peak of the A upwards and by supporting the bottom parts of the A against the ground. The ballistic shelter thus comprises an A-shaped frame and the actual ballistic shelter is implemented with separate protective plates that are connected to the A-frame. A second alternative is to bring to the site just the bare A-frame, in which spaces are formed for filling. These spaces are filled with on-site earth, such as sand, for achieving ballistic protection. Shelters with a flat roof are raised upwards with a solution similar to an articulated jack, in which case people can shelter below the raised plate. In such a case, ballistic protection is only provided in the direction of incoming from above.

A second corresponding solution for a ballistic shelter for people is revealed in specification U.S. Pat. No. 10,739,113 B1. In it, a ballistic shelter is constructed on top of an erectable load-bearing frame. One or more panels providing ballistic protection are fastened to the frame. The purpose is to provide a rapidly erectable shelter for an individual person. Another solution for achieving a ballistic shelter is to erect an L-shaped shelter by lifting a wall providing ballistic protection to the upright position by means of a hydraulic cylinder and turning mechanism. In such a case, the wall rises to become upright around a hinge point. Alternatively, the ballistic protective wall can be erected by means of an articulated jack and the ballistic wall comprises two parts connected in a hinged manner to each other.

Solutions according to prior art are designed for personal use and movable ballistic shelters are not known to have been manufactured as larger constructions. Conventionally, shelters are constructed by using separate roof trusses, onto which battens are placed, and then sarking and roof covering on top of the battens. Ballistic protection is not known to be provided in these types of structures.

The solution according to the invention eliminates the problems of prior art and provides an easily transportable ballistic shelter that is assembled from a number of similar modular parts. Owing to its modularity, the ballistic shelter is easily adaptable to the conditions needed. Owing to its modularity, all the structures of the ballistic shelter can be packed into intermodal containers or into assemblies of the size of intermodal containers, in which case special transportation is not needed. This enables transportation of a ballistic shelter with transporting/handling means intended for transporting standard intermodal containers.

The modular ballistic shelter according to the invention is a self-supporting structure comprising a self-supporting roof structure connected to the walls of the building. In this case, the ballistic shelter does not need a separate frame structure, such as a beam frame, roof trusses or corresponding. The ballistic shelter can be erected quickly, in less than 12 hours, into a finished structure. Likewise, it can be quickly disassembled and conveyed to a different location if the need arises. As the ballistic shelter is fabricated without a frame structure, a significant saving in weight is gained in the total weight of the ballistic shelter. The ballistic shelter according to the invention is suited more particularly, but not exclusively, to the protection of aircraft.

In the following the invention will be described in more detail with the aid of some examples of its embodiment with reference to the attached simplified drawing, wherein

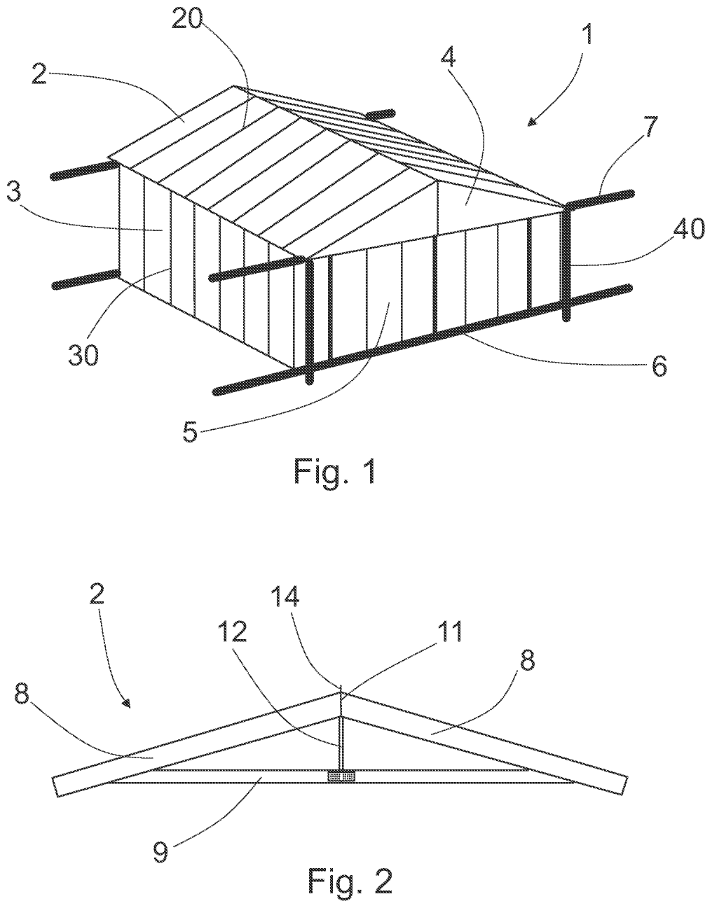

FIG. 1 presents a simplified schematic drawing of a preferred ballistic shelter according to the invention, when assembled

FIG. 2 presents a simplified schematic drawing of a preferred roof module of the ballistic shelter, as viewed from the gable end of the building,

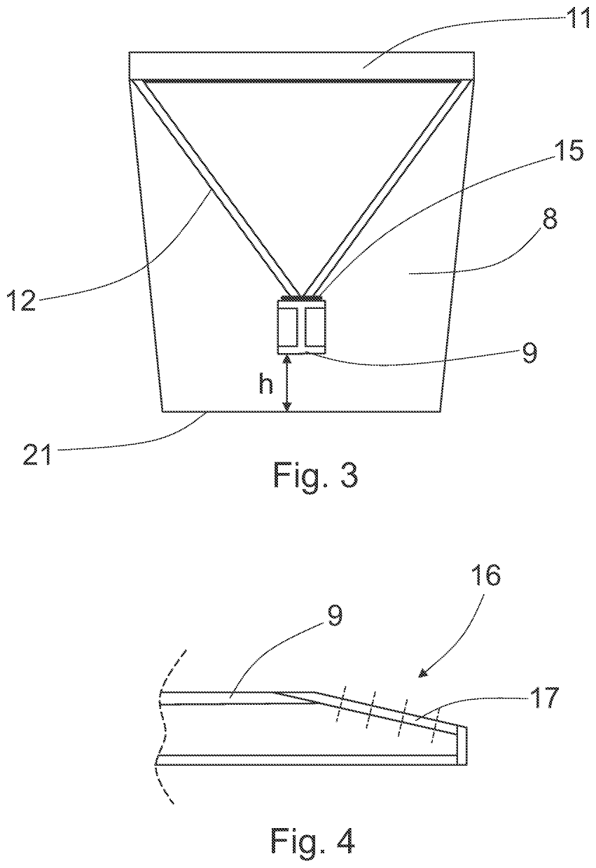

FIG. 3 presents a simplified schematic drawing of a roof structure of the ballistic shelter according to FIG. 2, as viewed from the side of the ballistic shelter,

FIG. 4 presents a simplified schematic drawing of a preferred end of a bottom chord of a roof module of the ballistic shelter,

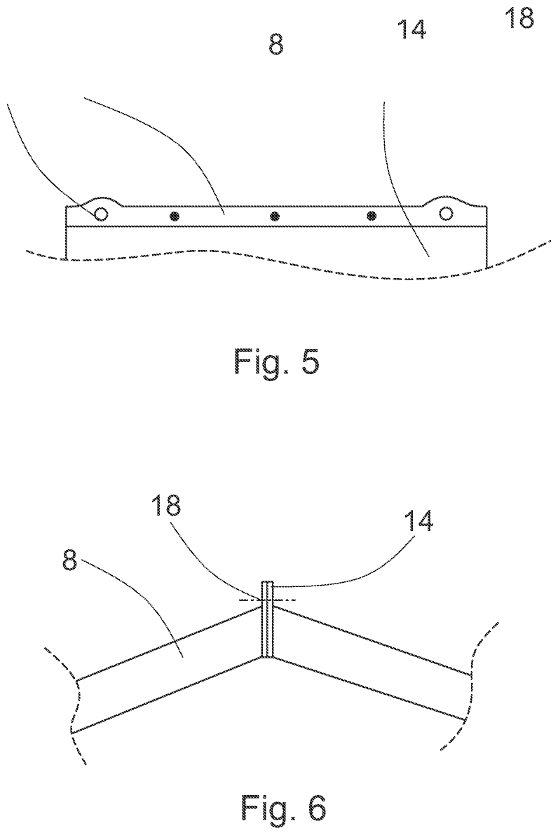

FIG. 5 presents a simplified schematic drawing a preferred coupling flange of the roof structure of the ballistic shelter, as viewed from the side of the ballistic shelter

FIG. 6 presents a simplified schematic drawing of the coupling flanges of the roof structures of the ballistic shelter according to FIG. 5, when connected, as viewed from the direction of the gable end, and

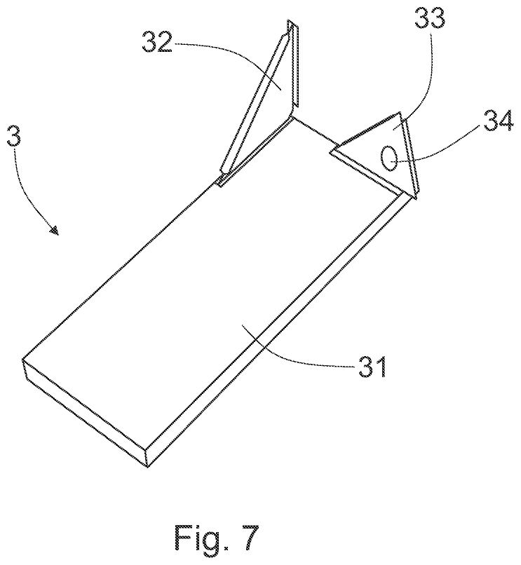

FIG. 7 presents a simplified schematic drawing of a preferred wall module of the ballistic shelter.

FIG. 1 presents a simplified schematic drawing of a preferred embodiment of the ballistic shelter 1 according to the invention. The ballistic shelter 1 comprises roof modules 2, wall modules 3, triangular gable end modules 4 and preferably, but not necessarily, an arrangement for installing sliding doors 5 in the end or ends of the ballistic shelter. All the modules 2, 3 and 4, or parts of said modules, needed for fabrication of the ballistic shelter 1 can be packed into intermodal containers/assemblies of the size of intermodal containers for transport, in which case it is not necessary to arrange special transportation for them. All the structures required by the ballistic shelter 1 can be transported and moved with means intended for handling and transporting intermodal containers. Erection of the ballistic shelter 1 according to the invention can be performed in less than 12 hours, owing to which a shelter, e.g. for airplanes, is quickly obtained. The ballistic shelter 1 is assembled by joining similar roof modules and wall modules 2 and 3, which enables the fabrication of different-sized ballistic shelters using similar modules. The ballistic shelter 1 can also be quickly disassembled and can easily be conveyed to, and assembled in, a new erection site.

The roof structures, wall structures and door structures of the ballistic shelter 1 are fabricated from a honeycomb structure providing ballistic protection. The honeycomb structure can be any honeycomb structure whatsoever known in the art that is self-supporting and provides the ballistic protection needed in any given location. The material of the honeycomb structure is preferably e.g. armor steel. Also the triangular gable end modules 4 are fabricated from armor steel and they also provide ballistic protection. Two triangular gable end modules 4 are joined to each other, whereby the gable ends of the ballistic shelter 1 are formed. If the ballistic shelter is smaller in its dimensions, the gable end can also be fabricated as a single triangular gable end module 4. The triangular gable end modules 4 preferably hold inside themselves the operating mechanisms of the sliding doors 5. The sliding doors 5 preferably move on a channel rail 6 and are supported at their top edge with overhead support structures 7. If the ballistic shelter 1 is provided with a sliding door arrangement, it is advantageous to connect vertical beams 40 to the sliding door arrangement, which beams support the outermost roof modules 2 and the triangular gable end modules 4 at the corners of the roof structure of the ballistic shelter. The vertical beams 40 can be supported at their bottom part directly on the ground or can be connected to the channel rails 6 by means of a widening on the channel rails. What is essential is that the vertical beams 40 support the roof structure at the corners of the ballistic shelter 1 and enable movement of the sliding doors 5 between the vertical beams and the wall modules 3 of the end walls of the ballistic shelter in the direction of the wall modules.

The ballistic shelter 1 according to the invention can be installed directly e.g. onto a flat paved surface or onto a flat sandbed. If necessary, the ballistic shelter 1 can be fastened to a paved surface e.g. by anchoring or with anchor bolts into the surface. If the ballistic shelter 1 is installed in a more demanding site, such as terrain, the ballistic shelter can be installed onto a separate foundation (not shown in FIG. 1). Such a foundation can also be brought to the site as a modular unit without special transportation. The foundation of the ballistic shelter can be e.g. concrete-structured or steel-structured.

The ballistic shelter 1 does not need a separate frame or roof trusses, but instead the structure is self-supporting. If necessary, therefore, foundations are installed for the ballistic shelter 1, onto which foundations the wall modules 3 are installed. The triangular gable end modules 4 are installed on top of the wall modules 3 of the ballistic shelter 1 and the roof modules 2 pre-assembled on a jig can be lifted directly onto the top of the wall modules and triangular gable end modules. All the modules 2, 3 and 4 comprise fastening means according to the need of each module, such as fixing flanges or corresponding, for fastening the modules to each other and, if necessary, to optional foundations/an assembly bed.

The wall modules 3 are connected to the roof modules 2 at their interfaces with a mechanical joint and with vertical support means, which support means are described hereinafter and which give the structure the necessary rigidity for the joint between the wall modules 2 and the roof modules 2. Likewise, the wall modules 3 at the corners of the ballistic shelter 1 are preferably connected to each other with the horizontal support means described hereinafter as well as with the mechanical joint of the interfaces. Adjacent roof modules 2 are preferably connected to each other with mechanical joints, such as e.g. with bolts and nuts. Likewise, adjacent wall modules 3 are preferably connected to each other with corresponding mechanical joints. The roof modules, wall modules and triangular gable end modules 2, 3 and 4 have the coupling flanges needed for fastening them to each other with mechanical joints.

The interfaces 20 between roof modules 2 and the interfaces 30 between wall modules according to FIG. 1 are not at the same point of the ballistic shelter 1, but instead the interfaces of the roof modules are preferably situated on the center line of the wall modules and, correspondingly, the interfaces of the wall modules are situated on the center line of the roof modules. This kind of placement makes the structure of the ballistic shelter 1 more robust.

FIG. 2 presents a simplified schematic drawing of one roof module 2 of the invention. The roof module 2 comprises two honeycomb-structured roof panels 8, a bottom chord 9, which is preferably an I-beam, and a center support 12. The I-beam functions as a bottom chord 9, in which case no separate frame or support structures, such as a beam frame, roof trusses or corresponding, are needed in the roof structures or other structures of the ballistic shelter 1. The honeycomb structure of the roof panels 8 providing ballistic protection together with the bottom chord 9 make the structure self-supporting. The bottom chord 9 is situated at the center point of the roof module 2, and a center support 12 of triangular shape is between the bottom chord and the ridge 11 of the roof module, which center support is connected with a mechanical joint to the bottom chord and to the ridge of the roof module. The bottom chord 9 can be a unitary beam or it can be assembled from two separate parts, as in FIG. 2, that are connected to each other with connecting means 13. Such connecting means 13 are preferably e.g. support plates to be fastened with bolted joints. From the viewpoint of transportation of the ballistic shelter 1, the length of an intermodal container sets a limit to whether the bottom chord 9 is unitary or assembled from two pieces. In smaller solutions for a ballistic shelter 1, therefore, a unitary bottom chord 9 can be used. On the ridge 11 of a roof module 2 are coupling flanges 14 on both roof panels, with which flanges the roof panels 8 of a roof module 2 are connected to each other with a mechanical joint. There are also lifting holes in the coupling flanges 14 (not presented in FIG. 2), from which the roof module 2 can be lifted into its position on top of the wall modules. The structure of the roof modules 2 enables lifting of the roof modules into their position from the ridge 11 of the roof module without buckling the structure, in which case erection of the ballistic shelter is fast.

FIG. 3 presents a simplified schematic drawing of a preferred roof structure of the ballistic shelter 1, as viewed from the side of the ballistic shelter. A center support 12 of triangular shape is connected to a honeycomb-structured roof panel 8 at the point of its ridge 11 from one side of the triangle. The opposite tip of the triangle is connected to an I-beam functioning as a bottom chord 9 using the fixing flange 15 and a mechanical joint. The bottom chord 9 is fastened at its end to the roof panel 8 with a mechanical joint. The fixing point of the bottom chord 9 to the roof panel 8 is preferably at a distance h from the bottom edge 21 of the roof panel. This distance is determined by the vertical support means connecting the roof module and the wall module, presented hereinafter in FIG. 7. The support means in this embodiment is preferably of triangular shape. Preferably, but not necessarily, the bottom chord 9 is disposed immediately above the support means. A solution can be implemented as another preferred embodiment in such a way that the bottom chord 9 is fastened starting from the bottom edge 21 of the roof module and the support means of triangular shape between the roof module and the wall module is fastened at the roof module directly to the bottom chord. Yet another alternative solution is to fabricate a support means in such a way that it is partly fastened both to the roof panel and to the bottom chord. In such a case, the shape of the side of the support means coming against the bottom chord 9 and the roof panel 8 is, of course, a side forming two separate straight sections. In other words, the shape of the support means changes from triangular to quadrilateral. The support means is presented in more detail in connection with FIG. 7.

FIG. 4 presents a simplified schematic drawing of a preferred end 16 of a bottom chord of a roof module of a ballistic shelter. The bottom chord 9 is preferably an I-beam, which comprises one or two parts. The ends 16 of the bottom chord 9, which are fastened with a mechanical joint to the roof panels, are shaped to correspond to the pitch of the roof panel. Furthermore, the plate-shaped additional flanges 17 of the I-beam are connected to the end of the bottom chord 9 by welding, from which flanges the bottom chord is fastened to the roof panel. The bottom chord 9 can be fully beveled or, as presented in FIG. 4, partly beveled.

FIG. 5 presents a simplified schematic drawing of a preferred coupling flange of the roof structure of the ballistic shelter, as viewed from the side of the ballistic shelter. The honeycomb-structured roof panels 8 are connected to each other with a mechanical joint by means of coupling flanges 14. The coupling flanges 14 also have lifting holes 18, from which the roof module 2 is lifted into position. During the lifting, compression is exerted on the I-beam functioning as a bottom chord 9, instead of tension.

FIG. 6 presents a simplified schematic drawing of preferred coupling flanges 14 of the roof panels 8 of the ballistic shelter when connected, as viewed from the direction of the end of the ballistic shelter. The coupling flanges 14 are fastened to each other with a mechanical joint and the roof module is lifted from the lifting holes 18 of the coupling flanges onto the top of the wall panels. The roof module is preferably pre-assembled on a jig and lifted onto the top of the pre-erected wall modules and triangular gable end modules.

FIG. 7 presents a simplified schematic drawing of a preferred wall module 3 of a ballistic shelter. The wall module 3 comprises a honeycomb-structured wall panel 31 providing ballistic protection, to which panel a vertical support means 32 is fastened for connecting the wall module with a mechanical joint to the roof module. In this embodiment, the support means 32 is of triangular shape and is fastened on one of its sides to a roof element and on another of its sides to a wall panel 31. Alternatively, the vertical support means 32 can be fastened, in the manner described earlier, at one of its sides also to the bottom chord of the roof module instead of the roof element. Also fastening of a support means 32 to a roof element and a bottom chord is possible. In such a case, the vertical support means 32 is quadrilateral instead of triangular. The vertical support means 32 has the coupling flanges needed for connecting it with a mechanical joint to the wall panel and roof module. A second horizontal support means 33 is also presented in the wall module 3 presented in FIG. 7. This type of horizontal support means 33 is preferably triangular in shape and only in the corners of the ballistic shelter. The wall modules 3 at the corners of the ballistic shelter can in this way be more firmly connected to each other. The horizontal support means 33 also comprises the fixing flanges needed for mechanical fastening. The support means 32 and/or 33 presented earlier can also have weight-reducing holes 34 for optimizing the weight of the structure. The horizontal support means 33 of the wall modules 3 can be fastened first to the wall elements of the side walls and only during erection connectable to the wall elements of the end wall or vice versa. It is also reasonable that there are no vertical support means 32 on the wall modules 3 that are at the ends of the ballistic shelter. All the modules, and parts of modules, of the ballistic protection are connected to each other by means of coupling flanges/connection points with mechanical joints.

The invention thus provides a self-supporting ballistic shelter that does not need a separate frame structure or roof trusses. Self-supporting honeycomb board structures providing ballistic protection are connected to each other with mechanical joints and with support elements, which enhance the rigidity of certain joints in the structure. More particularly, the structure of the roof module, which comprises two honeycomb board elements providing ballistic protection, a bottom chord and a center support, enables the achievement of a significantly more lightweight solution than conventional construction methods since the roof structure can be fabricated without a separate support structure and can utilize the inherent rigidity of the ballistic shelter. The combination of the honeycomb board structure of the roof module and the bottom chord bear the stresses of lifting the roof module, snow loads and also explosion loading. Joining a roof module with a wall module by means of support means makes the structure sufficiently rigid, in which case erecting the structure is possible without separate support from the foundation or from the ground.

What is also essential is that all the elements of the ballistic shelter can be transported with equipment suited to the transportation of intermodal containers, because all the necessary structures fit into intermodal containers or form, on the transportation base, loads of at most the size of intermodal containers. One advantage of the solution according to the invention is the rapid assembly of the ballistic shelter, whereby the ballistic shelter is fully erected in less than 12 hours. The ballistic shelter can also be quickly disassembled and conveyed to another location.

The method for fabricating a ballistic shelter 1 also comprises at least some of the following phases:
the foundations for the ballistic shelter 1 are produced by assembling the foundations from modules.
the self-supporting wall modules 3 of the ballistic shelter 1 are produced from a honeycomb structure 31 providing ballistic protection and the wall modules are lifted upright onto the foundations of the ballistic shelter or directly onto an installation base,
the wall modules 3 are connected to each other,
the vertical support means 32 for the wall modules 3 of the side walls of the ballistic shelter 1 are produced,
the horizontal support means 33 for the wall modules 3 of the side wall or end wall at the corners of the ballistic shelter 1 are produced,
triangular gable end modules 4 are produced and two triangular gable end modules are lifted onto the top of the wall modules 3 forming the end walls, in which case the triangular gable end modules form a triangular gable end, or one triangular gable end module 4 forming the entire triangular gable end is produced,
the triangular gable end modules 4 are supported with vertical beams 40 at the corners of the ballistic shelter,
the triangular gable end modules 4 are fastened to the wall modules 3 forming the end walls of the ballistic shelter 1,
the triangular gable end modules 4 are provided with a sliding door arrangement comprising sliding doors 5, a sliding door mechanism and drive apparatus, whereby the sliding door mechanism also comprises a channel rail 6 in its bottom part for the sliding doors and a support structure 7 for the sliding doors in its top part,
the roof module 2 of the ballistic shelter 1 is produced from a self-supporting honeycomb structure providing ballistic protection from prefabricated honeycomb board elements 8, a bottom chord 9 and a center support 12,
the roof elements 2 are pre-assembled on top of a jig,
the honeycomb board elements 8 of the roof module 2 are connected to each other with flanges 14 at the ridge 11 of the roof module,
the roof modules 2 are lifted onto the top of the wall modules 3 of the side walls and the triangular gable end modules 4 of the ballistic shelter 1 from the lifting holes 18 in the ridge 14 of the roof module and fastened to them, and
the roof modules 2 are fastened to the adjacent roof modules.

The method according to the invention thus includes one or more of the aforementioned phases, and the phases are not necessarily in the same sequence that is presented. The aforementioned numbering in the phases of the method refer to the numbering in FIGS. 1-7.

It is obvious to the person skilled in the art that the invention is not limited solely to the examples described above, but that it may be varied within the scope of the claims presented below. For example, it is possible that the ballistic shelter can be provided with the lead-ins needed for bringing HEPAC/electricity services or the wall modules can be provided with the necessary number of doors/hatches.

1. A ballistic shelter comprising a wall structure, a roof structure and triangular gable ends providing ballistic protection, whereby the aforementioned wall structure and roof structure comprise honeycomb board elements, wherein the ballistic shelter is self-supporting and comprises roof modules comprising at least two honeycomb board elements, a bottom chord and a center support, wall modules comprising at least a honeycomb board element and vertical support elements on the honeycomb board elements of the side walls of the ballistic shelter as well as horizontal support elements at the corners of the ballistic shelter, and triangular gable end modules.

2. The ballistic shelter according to claim 1, wherein the ballistic shelter further comprises a sliding door arrangement for sliding doors, the arrangement comprising a channel rail in its bottom part, a support structure in its top part, vertical beams in the corners of the ballistic shelter and an operating mechanism inside the triangular gable end module(s).

3. The ballistic shelter according to claim 1, wherein the bottom chord is an I-beam, which comprises one or two parts, whereby the parts are connected to each other with a mechanical joint, and the ends of the bottom chord to be fastened to the honeycomb board element are at least partly beveled to correspond to the pitch of the honeycomb board elements of the ballistic shelter.

4. The ballistic shelter according to claim 1, wherein two honeycomb board elements of the roof module are fastened to each other with a mechanical joint at the point of the ridge of the roof module by means of a flange.

5. The ballistic shelter according to claim 1, wherein in the flanges of the ridge of the roof module are lifting holes for lifting the roof module.

6. The ballistic shelter according to claim 1, wherein the center support is triangular in shape and is fastened at one of its sides to the ridge of the roof module and fastened at its tip opposite the aforementioned side to the bottom chord with a fixing flange and with a mechanical joint.

7. The ballistic shelter according to claim 1, wherein the bottom chord is fastened to the bottom edge of the honeycomb board elements of the roof module or to a height from the bottom edge.

8. The ballistic shelter according to claim 1, wherein the ballistic shelter is erected on concrete foundations or steel foundations.

9. The ballistic shelter according to claim 1, wherein the ballistic shelter is erected to rest on the ground.

10. A method for fabricating a ballistic shelter, the method comprising the following phases:
a wall structure of the ballistic shelter wall is produced,
a roof structure of the ballistic shelter wall is produced,
gable end triangles of the ballistic shelter wall are produced,
the aforementioned structures are connected with mechanical joints into a ballistic shelter,
wherein
the wall structure, roof structure and gable end triangles are formed into modular structures,
a wall module is produced from a self-supporting honeycomb board element providing ballistic protection,
a roof module is produced from a self-supporting honeycomb board element providing ballistic protection, a center support and a bottom chord,
triangular gable end modules are produced from an armor steel structure providing ballistic protection,
the wall modules and roof modules are connected to each other with vertical support means in the case of the side walls of the ballistic shelter, and
the wall modules are connected to each other with horizontal support means at the corners of the ballistic shelter.

11. The method according to claim 10, wherein ballistic shelter is provided with a sliding door arrangement comprising sliding doors, a channel rail, an overhead support structure and vertical beams.

12. The method according to claim 10, wherein the honeycomb board elements of the roof module are connected to each other with flanges and a mechanical joint.

13. The method according to claim 10, wherein the roof module is lifted into its position on top of the wall modules and the triangular gable end modules from the lifting holes of the flanges.

14. The method according to claim 13, wherein the roof module is pre-assembled on a jig and lifted as a finished roof module onto the top of the wall modules and the triangular gable end modules.

15. The method according to claim 10, wherein modular foundations of steel or concrete are produced for the ballistic shelter.
